(19) United States
(12) Patent Application Publication
(10) Pub. No.: US 2017/0088763 A1
(43) Pub. Date: Mar. 30, 2017

(54) INTERNAL BREAKER COMPOSITIONS FOR WELLBORE APPLICATIONS

(71) Applicant: M-I L.L.C., Houston, TX (US)

(72) Inventors: Changping Sui, Houston, TX (US); Pawilai Chinwangso, Houston, TX (US); Hui Zhang, Sugar Land, TX (US)

(73) Assignee: M-I L.L.C., Houston, TX (US)

(21) Appl. No.: 15/276,171

(22) Filed: Sep. 26, 2016

Related U.S. Application Data
(60) Provisional application No. 62/234,407, filed on Sep. 29, 2015.

(51) Int. Cl. C09K 8/34; E21B 37/06; C09K 8/035

(52) U.S. Cl. CPC C09K 8/34; C09K 8/035; E21B 37/06; C09K 2208/02; C09K 2208/26; E21B 21/003

(57) ABSTRACT

Methods may include circulating a first wellbore fluid into a wellbore, wherein the first wellbore fluid contains: a non-aqueous continuous phase, and a polyester internal breaker; wherein the first wellbore fluid generates a filter cake in at least a section of the wellbore; circulating a second wellbore fluid into the wellbore, wherein the second wellbore fluid contains an acid source and a surfactant; and allowing the second wellbore fluid to degrade at least a portion of the filter cake. Other methods may include circulating a wellbore fluid into a wellbore drilled with an oil-based mud containing a polyester fluid loss additive, wherein the wellbore fluid comprises one or more surfactants and an acid source.

### CROSS-REFERENCE TO RELATED APPLICATIONS

This application claims priority to U.S. Application No. 62/234,407, filed on Sep. 29, 2015, the contents of which are incorporated by reference.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

Upon completion of drilling, a filter cake may develop on the surfaces of a wellbore from the accumulation of additives from a drilling fluid. This filter cake may stabilize the wellbore during subsequent completion operations such as placement of a gravel pack in the wellbore. Additionally, during completion operations, when fluid loss is suspected, a fluid loss pill of polymers and/or bridging agents may be spotted into the wellbore to reduce or prevent such fluid loss by injection of other completion fluids behind the fluid loss pill to a position within the wellbore which is immediately above a portion of the formation where fluid loss is suspected. Injection of fluids into the wellbore is then stopped, and fluid loss will then move the pill toward the fluid loss location.

After any completion operations have been finalized, filter cakes generated during drilling and fluid loss treatments may be removed. However, depending on the components used to generate the filter cake, these same components may become barriers that impede subsequent downhole operations, such as the production of hydrocarbons or other fluids from the well or enhanced oil recovery in which water and/or gas are injected into the formation. Filter cakes may become compacted or adhere to the formation in some cases, and removal may require the use of chemical treatments, often referred to as breaker fluids, where fluid action alone is not enough to repair formation damage.

### SUMMARY

In one aspect, embodiments are directed to a method that includes circulating a first wellbore fluid into a wellbore, wherein the first wellbore fluid comprises: a non-aqueous continuous phase, and a polyester internal breaker, wherein the first wellbore fluid generates a filter cake in at least a section of the wellbore. The method also includes circulating a second wellbore fluid into the wellbore, wherein the second wellbore fluid comprises an acid source and a surfactant; and allowing the second wellbore fluid to degrade at least a portion of the filter cake.

In another aspect, embodiments are directed to a method that includes circulating a wellbore fluid into a wellbore drilled with an oil-based mud containing a polyester fluid loss additive, wherein the wellbore fluid comprises one or more surfactants and an acid source.

### DETAILED DESCRIPTION

Embodiments disclosed herein are directed to a chemical system for controlling or modifying fluid loss during wellbore operations that is paired with a breaker fluid composition that may enhance cleanup and removal of formation damages incurred during the fluid loss treatment. In one or more embodiments, wellbore fluid formulations in accordance with the present embodiment may be oil-based muds (OBM) containing a polymeric material that operates as an fluid loss control additive during drilling operations, but that degrades when exposed to breaker fluids containing selected chemical additives. More particularly, this work relates to incorporation of a polymeric internal breaker into an OBM that serves dual functions as a fluid loss additive during wellbore operations such as drilling, spotting, displacement, and the like, and then as a breaking agent that generates reactive byproducts when exposed to a breaker fluid. Internal breakers in accordance with the present disclosure may aid removal of OBM filter cakes and residues that exhibit limited solubility in standard breaker fluids, which may result in enhanced wellbore cleanup and increased return permeability.

The wellbore fluid composition and breaker fluid systems in accordance with the present disclosure may be used in conjunction to treat fluid loss, while enabling facile removal of formation damage, which may result in enhanced well productivity. In one or more embodiments, internal breaker compositions may be incorporated diverting treatment used to treat permeable regions of the formation in order to divert injected fluids to less permeable intervals of the formation. For example, following the placement of a diverting treatment, fluid flow into permeable thief zones may be decreased or stopped, which may allow for more uniform contact between less permeable intervals and any subsequent wellbore treatments or stimulating treatments known in the art.

In some embodiments, internal breaker compositions may be used in diverting applications in order to redirect fluids to lower permeability regions of a wellbore. For example, by using a wellbore fluid composition containing an internal breaker to seal higher permeability regions or intervals of the wellbore, stimulating treatments may be applied to increase the porosity and permeability of targeted intervals in order to increase the production of hydrocarbons. In another example, a wellbore fluid composition containing an internal breaker may increase the effectiveness of enhanced oil recovery techniques like steam flooding in which steam is injected into a neighboring injection well. When steam enters the reservoir, it heats up the crude oil and reduces its viscosity. The hot water that condenses from the steam and the steam itself generate an artificial drive that sweeps oil toward producing wells. The driving force of the steam flood is then used to drive hydrocarbons into the production well.

When formulated as a fluid loss pill or diverting treatment, wellbore fluids in accordance with the present specification may be injected into a work string, flow to bottom of the wellbore, and then out of the work string and into the annulus between the work string and the casing or wellbore. The pill may be pushed by injection of other completion fluids to a position within the wellbore which is immediately above a portion of the formation where fluid loss is suspected. Injection of fluids into the wellbore is then stopped, and fluid loss will then move the pill toward the fluid loss location. Positioning the pill in such a manner is often referred to as “spotting” the pill. The fluid loss pill or diverting treatment may then react with the brine to form a plug near the wellbore surface, to reduce fluid flow into the formation.

Internal Breakers

In one or more embodiments, wellbore fluids in accordance with the present disclosure may include a multifunctional internal breaker that may control or modify fluid loss during an initial wellbore operation, but that may undergo hydrolysis or degradation during subsequent operations to minimize formation damage and/or to enhance fluid movement through the formation near the borehole. In some embodiments, the internal breaker may include compounds that release an acid upon hydrolysis or degradation following an appropriate stimulus such as contact with aqueous fluids or contact with chemical breakers or surfactants.

In particular, compounds that hydrolyze to form acids in situ may be utilized as an internal breaker. Such internal breaker may operate as a delayed source of acidity provided, for example, by hydrolysis of an ester or anhydride. Illustrative examples of internal breakers in accordance with embodiments of the present disclosure include esters of carboxylic acids, anhydrides of carboxylic acids, esters of phosphonic acid, esters of sulfonic acid and other similar hydrolyzable compounds that are known to those skilled in the art.

In one or more embodiments, the internal breaker may be an aliphatic polyester such as polyglycolic acid (PGA), polylactic acid, polymers or co-polymers of esters that include, for example, substituted and unsubstituted polylactide, polyglycolide, polylactic acid, poly(lactic-co-glycolic acid), polyglycolic acid, poly(ε-caprolactone), and the like. In some embodiments, internal breakers in accordance with the present disclosure may contain one or more selected from homo- or copolymers of lactic acid and glycolic acid as well as compounds containing hydroxy, phenoxy, carboxylic, hydroxycarboxylic or phenoxycarboxylic moieties. In some embodiments, the internal breaker may be selected from commercially available polymers such as DuPont™ PGA TLF 6267, which is distributed as a 20 micronized polymer having an weight average molecular weight (M_{w}) of 600 Da, or Kuredux™ available from Kureha, which is a high molecular weight internal breaker having an M_{w} around 20 kDa and available in a range of particles sizes such as 20, 50, 200 μm.

In one or more embodiments, internal breakers in accordance with the present disclosure may be added to wellbore fluids in an amount ranging from a lower limit equal or greater than 0.01 ppb, 0.1 ppb, 0.5 ppb, 1 ppb, and 5 ppb, to an upper limit of 0.5 ppb, 1 ppb, 5 ppb, 10 ppb, and 15 ppb, where the concentration of the internal breaker, or combinations thereof, may range from any lower limit to any upper limit. In some applications, it also may be desirable for the amounts of each fiber type to be in excess of the ranges described above. Moreover, it is within the scope of the present disclosure for any of the above described fibers to be combined as required by downhole conditions.

In one or more embodiments, internal breakers in accordance with the present disclosure may have a molecular weight ranging from a lower limit selected from any of 100 Da, 200 Da, 400 Da, 600 Da, 800 Da, and 1 kDa, to an upper limit selected from any of 1 kDa, 5 kDa, 10 kDa, 20 kDa, 30 kDa, and 50 kDa, where any lower limit may be used with any upper limit. As used in the present disclosure, molecular weight refers to weight average molecular weight (M_{w}) unless indicated otherwise.

In one or more embodiments, internal breakers in accordance with the present disclosure may have a particle size ranging from a lower limit selected from any of 1 μm, 5 μm, 10 μm, 15 μm, to an upper limit selected from any of 20 μm, 50 μm, 100 μm, and 200 μm, where any lower limit may be used with any upper limit.

Breaker Fluids

Breaker fluids in accordance with the present disclosure may incorporate one or more acids, surfactants, and/or chelants. In one or more embodiments, breaker fluids may activate an internal breaker present in the filter cake and/or residue deposited by an OBM. The selection of the various breaker fluid components may be based on a number of variables that include formation temperatures, composition of the OBM, pH, and concentration of the internal breaker present, and may be used to control the rate of activation of the internal breaker and thereby the rate and level of wellbore cleanup.

In one or more embodiments, breaker fluids in accordance with the present disclosure may contain one or more acid sources. For example, breaker fluids in accordance with the present disclosure may incorporate acids, including mineral acids such as hydrochloric acid, hydrofluoric acid, nitric acid, phosphoric acid and sulfuric acid, or organic acids such as formic acid, acetic acid, glycolic acid, citric acid and phosphonic acid. In some embodiments, breaker fluid formulations may also include compounds that generate acids as a result of decomposition or hydrolysis, such as an acid produced from the hydrolysis of esters, amides, anhydrides, carbamates, urethanes, ureas, and the like.

In some embodiments, breaker fluid compositions may include one or more carboxylic acid esters that hydrolyze in response to downhole conditions, such as temperature and pH. Carboxylic acid esters may include organic acid esters of a C2-C30 alcohol, which may be mono- or poly-hydric, such as an alkylene glycol monoformate or diformate. In embodiments, the delayed acid source may be the hydrolysable ester D-STRUCTOR™ available from M-I L.L.C. (Houston, Tex.). Other esters that may find use in activating the internal breaker of the present disclosure include those releasing C1-C6 carboxylic acids, including hydroxycarboxylic acids formed by the hydrolysis of lactones, such as γ-lactone and δ-lactone). In another embodiment, a hydrolyzable ester of C1 to C6 carboxylic acid and a C2 to C30 poly alcohol, including alkyl orthoesters, may be used.

Breaker fluids in accordance with the present disclosure may also incorporate one or more chelating agents. Chelating agents sequester polyvalent cations through bonds to two or more atoms of the chelating agent. Chelating agents may act to remove structural components from the filter cake, weakening the overall structure and aiding in filter cake removal. For example, cations sequestered by the chelants may be sourced from solid filter cake components including various weighting or bridging agents such as calcium carbonate, barium sulfate, etc. Useful chelating agents may include organic ligands such as ethylenediamine, diaminopropane, diaminobutane, diethylenetriamine, triethylenetetraamine, tetraethylenepentamine, pentaethylenehexamine, tris(aminoethyl)amine, triaminopropane, diaminoaminoethylpropane, diaminomethylpropane, diaminodimethylbutane, bipyridine, dipyridylamine, phenanthroline, aminoethylpyridine, terpyridine, biguanide and pyridine aldazine.

Chelating agents suitable for use in the breaker fluids of the present disclosure may include polydentate chelating agents such as ethylenediaminetetraacetic acid (EDTA), diethylenetriaminepentaacetic acid (DTPA), nitrilotriacetic acid (NTA), ethylene glycol-bis(2-aminoethyl)-N,N,N′,N′-tetraacetic acid (EGTA), 1,2-bis(o-aminophenoxy)ethane-N,N,N′,N′-tetraacetic acid (BAPTA), cyclohexanediaminete-traacetic acid (CDTA), triethylenetetraaminehexaacetic acid (TTHA), N-(2-Hydroxyethyl)ethylenediamine-N,N′,N′-triacetic acid (HEDTA), glutamic-N,N-diacetic acid (GLDA), ethylene-diamine tetra-methylene sulfonic acid (EDTMS), diethylenetriamine penta-methylene sulfonic acid (DETPMS), amino tri-methylene sulfonic acid (ATMS), ethylene-diamine tetra-methylene phosphonic acid (EDTMP), diethylenetriamine penta-methylene phosphonic acid (DETPMP), amino tri-methylene phosphonic acid (ATMP), and mixtures thereof. Such chelating agents may include potassium or sodium salts thereof in some embodiments. However, this list is not intended to have any limitation on the chelating agents (or salt types) suitable for use in the embodiments disclosed herein.

Surfactants

In one or more embodiments, surfactants in accordance with the present embodiments may be formulated as a component of a breaker fluid used to trigger or increase the rate of the hydrolysis of an internal breaker present in a filter cake deposited by an OBM. In some embodiments, surfactants may enhance the removal of filter cakes or fluid loss pills from wellbore walls containing an internal breaker by facilitating the interaction between the oil-based filter cakes or fluid loss pills present on the walls of the wellbore and the aqueous breaker solution. Surfactants may also act to increase the mobility of an aqueous breaker fluid throughout oil-based filter cake, fluid loss pill, or gravel pack, which may increase the concentration of free water available for the hydrolysis reaction with the internal breaker. Surfactants in accordance with the present disclosure may be used to disrupt and assist in the removal of oil-based filter cakes or fluid loss pills used in fluid loss control applications, but may also be used to disrupt and/or assist in the removal of water-based or emulsified filter cakes as well.

In some embodiments, surfactants in accordance with the present disclosure may contain one or more alkyl polyglycosides. Alkyl polyglycosides are carbohydrate or saccharide derivatives that function as nonionic biodegradable surfactants and may have the general formula:

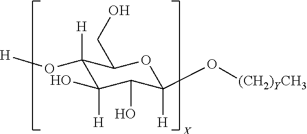

where the oligosaccharide portion contains one or more repeat units X, which may vary in number from 1 to 4. The alkyl portion of the alkyl polyglycoside may include a hydrocarbon tail containing a carbon chain length that may vary from 4 to 25 (with Y ranging from 3-24). In another embodiment, the carbon chain length may range from C8-C10 (Y values of 7-9). Suitable alkyl polyglycosides may include, for example, alkyl polyglucosides such as DESULF GOS-P-60WCG™ (DeForest) or Triton CG 110™ (Dow Chemical). In one or more embodiments, the alkyl polyglycosides may be incorporated within a breaker fluid, wherein the total volume of the alkyl polyglycoside is 1-20% of the total volume of the breaker fluid. In other embodiments, the alkyl polyglycoside may make up 2.5-10% of the total volume of the breaker fluid.

The ethoxylated alcohol surfactants of the present disclosure may be expressed as the formula (R¹)_{N}(R²)_{M}(R³)_{K}, which is also illustrated below:

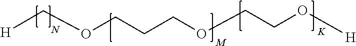

where R¹ is a hydrocarbon chain, R² represents propylene oxide, and R³ represents ethylene oxide. It is also noted that, while the above formula indicates that the molecule contains block units of each of R¹, R², and R³ it is also within the scope of the present disclosure that the units may alternate along the chain. The selection of N, M, and K may be based on the desired hydrophilic-lipophilic balance (HLB) for the molecule.

In one or more embodiments, ethoxylated alcohol surfactant in accordance with the present disclosure may contain a number of carbons in the hydrocarbon chain and the number of propylene oxide repeats calculated by the inequality 20<(3N)+M<40. In another embodiment, the number of ethylene oxide repeats may range from 6 to 15 (i.e. 6≦K≦15). In another embodiment, the HLB value of the ethoxylated alcohol may range from 10 to 15. In yet another embodiment, the ethoxylated alcohol may contain no polypropylene oxide groups. Examples of commercially available ethoxylated alcohols suitable for the application of the current disclosure include TOMADOL™ N91-8 and TOMADOL™ N91-6 (provided by Air Products) and ECO™ 9 (Dow Chemical). In some embodiments, the ethoxylated alcohol may be incorporated within a breaker fluid, wherein the total volume of the ethoxylated alcohol is 0.5-10% of the total volume of the breaker fluid. In other embodiments the ethoxylated alcohol may make up 1.25-5% of the total volume of the breaker fluid.

Breaker fluids in accordance with the present disclosure may also contain one or more mutual solvents selected from glycol ethers such as those formed from C1-C6 alcohols and C2-12 glycols including, but not limited to, dipropylene glycol methyl ether, hexylene glycol methyl ether, ethylene glycol monobutyl ether (EGMBE), and triethylene glycol monobutyl ether (TEGMBE). For example, TEGMBE may be used as a mutual solvent or hydrotrope in the present application, stabilizing organic materials in aqueous solvents or brines. In some embodiments, the TEGMBE may be substantially completely soluble in both oleaginous and non-oleaginous phase. In some embodiments, TEGMBE may be incorporated within a breaker fluid, wherein the total volume of the triethyleneglycol monobutyl ether is 0.5-10% of the total volume of the breaker fluid. In other embodiments the triethyleneglycol monobutyl ether may make up 1.25-5% of the total volume of the breaker fluid.

In some embodiments, the breaker fluid composition may include a surfactant blend that may include one or more of an alkyl polyglycoside, an ethoxylated alcohol, and a polyethyleneglycol monobutyl ether. It is also within the scope of the present disclosure that one or more of each type of component may be used in the surfactant blend, i.e., the surfactant blend may contain one or more alkyl polyglycosides, one or more ethoxylated alcohols, and one or more triethyleneglycol monobutyl ethers. In some embodiments, the surfactant blend may be compatible with standard aqueous breaker fluids and additives, such as acids, delayed acid sources, and oxidants known by those skilled in the art. In one or more embodiments, a breaker fluid may contain a surfactant package such as ECF-2557, a surfactant blend containing an alkyl polyglycoside, an ethoxylated alcohol, and a glycol, which is commercially available from M-I L.L.C. (Houston, Tex.).

In one or more embodiments, surfactants in accordance with the present disclosure may include quaternary ammonium surfactants. In some embodiments, surfactants may be quaternary ammonium compound represented by the formulae below:

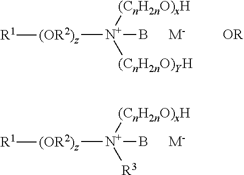

where R1 may be an alkyl or alkenyl group having at least 8 carbons; R2 may be an alkyl group having 2-6 carbon atoms; R3 may be an alkyl group having at least 4 carbons; n may be either 2 or 3; x+y is greater than 5, preferably 5-20; z ranges from 0 to 3; B is hydrogen, an oxyalkyl or alkyl having 1 to 4 carbons, and M is a counter anion, such as a halide. However, one skilled in the art would appreciate that that there may be a balance between the R1/R2 chain and the sum of x+y. That is, if the R1/R2 chain possesses more than 22 carbons, it may be desirable to increase the amount of alkoxylation to greater than 20 so that the compound remains amphiphilic, and vice versa. In particular embodiments, the R1 may be derived from various fatty acids having carbon numbers that range from C4 to C18 or greater. In some embodiments, the surfactant may be ECF-1989, an ethoxylated quaternary ammonium chloride, available from M-I L.L.C. (Houston, Tex.).

Breaker Base Fluids

Base fluids useful for preparing breaker fluid formulations in accordance with the present disclosure may include at least one of fresh water, sea water, brine, mixtures of water and water-soluble organic compounds, and mixtures thereof. In various embodiments, the aqueous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts.

Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation, for example). In a particular embodiment, a brine may include halide or carboxylate salts of mono- or divalent cations of metals, such as cesium, potassium, calcium, zinc, and/or sodium.

Other suitable base fluids useful in methods described herein may be oil-in-water emulsions or water-in-oil emulsions in one or more embodiments. Suitable oil-based or oleaginous fluids that may be used to formulate emulsions may include a natural or synthetic oil and in some embodiments, in some embodiments the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

Breaker fluids as disclosed herein may also be used in a cased hole to remove any drilling fluid left in the hole during any drilling and/or displacement processes. Well casing may consist of a series of metal tubes installed in the freshly drilled hole. Casing serves to strengthen the sides of the well hole, ensure that no oil or natural gas seeps out of the well hole as it is brought to the surface, and to keep other fluids or gases from seeping into the formation through the well. Thus, during displacement operations, typically, when switching from drilling with an oil-based mud to a water-based mud (or vice-versa), the fluid in the wellbore is displaced with a different fluid. For example, an oil-based mud may be displaced by another oil-based displacement to clean the wellbore. The oil-based displacement fluid may be followed with a water-based displacement fluid prior to beginning drilling or production. Conversely, when drilling with a water-based mud, prior to production, the water-based mud may be displacement water-based displacement, followed with an oil-based displacement fluid. Further, one skilled in the art would appreciate that additional displacement fluids or pills, such as viscous pills, may be used in such displacement or cleaning operations as well, as known in the art.

Another embodiment of the present disclosure involves a method of cleaning up a well bore drilled with an oil based drilling fluid. In one such illustrative embodiment, the method involves circulating a breaker fluid disclosed herein in a wellbore, and then shutting in the well for a predetermined amount of time, typically while production tubing and flow line are run, and/or the well is lined-up to the designated production facility, to allow penetration and fragmentation of the filter cake to take place. Subsequently the designated well is brought on-line whereby the initial clean-up of the well is initiated and fluids from the flowline, production tubing and finally the open hole flow to the surface thus transporting the now spent breaker fluid to the surface.

### EXAMPLES

The following examples are provided to demonstrate various approaches to preparing and using wellbore fluid formulated in accordance with the present disclosure.

### Example 1

In a first example, wellbore fluids were formulated using a 9.5 ppg oil-based wellbore fluid VERSAPRO™, obtained from M-I SWACO (Houston, Tex.). VERSAPRO™ includes VG PLUS™, an organophilic clay viscosifier, VERSACOAT™, an emulsifier and wetting agent; VERSAWET™, an organic surfactant; VERSAMOD™, an organic gelling agent; and SAFECARB™, a calcium carbonate bridging agent (all commercially available from M-I SWACO). Sample fluids were also formulated to contain a PGA internal breaker having a M_{w} of 600 and an average particle size of 20 microns. Prior to testing, samples were heat aged dynamically at 200° F. (93° C.) for 16 hours by hot rolling. Rheology was measured as shown in Table 1.

TABLE 1
OBM properties before and after hot roll
and heat aging at 200° F. (93° C.)

| Fann 35 | Base | Base + PGA | Base + PGA | Base + PGA |
|---|---|---|---|---|
| @ 150° F. | BH/AH | BH/AH | 5 days aging | 2 weeks aging |
| 600 RPM | 65/73 | 60/71 | 61 | 61 |
| 300 RPM | 41/45 | 36/42 | 35 | 35 |
| 200 RPM | 31/35 | 28/32 | 26 | 26 |
| 100 RPM | 21/24 | 19/20 | 16 | 15 |
| 6 RPM | 8.5/9 | 7/7 | 5 | 4 |
| 3 RPM | 7.5/8 | 6/6 | 4 | 3.5 |
| PY | 21/28 | 24/19 | 26 | 26 |
| YP | 16/17 | 12/13 | 9 | 9 |

### Example 2

In the following examples, samples where assayed at high temperature/high pressure (HTHP) with various breaker fluid formulations to analyze the efficiency of filter cake removal for a given combination of internal breaker and breaker fluid. In flow back experiments, the initial flow in both injection and production direction were measured on a selected aloxite filter disks. The data was recorded and the cell was decanted after flow. The aloxite disk was then saturated in water and then placed in modified HTHP cell and the device was calibrated to determine the initial rate of flow. Next, 4-hour filter cakes were built at 200° F. (93° C.)/500 psi. The mud was then decanted and the cell was filled with a selected breaker fluid formulation. The cell was then pressurized to 100 psi at 200° F. (93° C.). Next, the cell was pressured to a 500 psi differential, the bottom valve was opened, and the time was recorded when breakthrough occurred. The bottom valve was left open until 30 ml of effluent had been collected or until 30 minutes of time has elapsed. After 30 ml of effluent has been collected or 30 minutes of time has elapsed, the cell was closed and the pressure reduced to a 100 psi differential. The samples were the allowed to soak for a specified time. The time for breakthrough was recorded. Flowback in both directions was then conducted and the results were recorded. The decanted fluid and any remaining fluid were qualitatively measured by sight. After completion of breaker testing return to flow % was calculated in both directions as the ratio of the final flow rate to the initial flow rate multiplied by 100.

In the next example, an experiment was conducted to study the functionality of PGA as an internal breaker for OBM. Laboratory scale experiments were conducted by constructing filter cakes from VERSAPRO™ base mud containing 6.5 ppg of PGA as an internal breaker. Cleanup properties for the filter cake were then compared between the internal breaker alone or combined with various external breaker formulations. Sample muds were formulated substantially as described in Example 1 and aged 1 or 2 weeks at 200° F. (93° C.). Samples were then evaluated by building filter cakes on a FAO-00 aloxite disk for 4 hours and soaking the generated filter cakes for 5 days at 200° F. (93° C.) and 500 psi. Results are shown Table 2, where ECF 2557 is a surfactant blend and 5% D-Structor (DS) is a hydrolysable ester that generates acid when contacted with aqueous fluids, and the internal breaker polyglycolic acid (PGA) is applied at 6.5 ppb of the OBM. Results are shown in Table 2.

TABLE 2
Breaker test results for mud with internal and external breaker.

| | | Mud type: 9.5 ppg VersaPro | | |
|---|---|---|---|---|
| | | | Base + 6.5 | |
| | | Base | ppb PGA | Base + PGA |
| Soaking fluid/external breaker | | none | | 10 v % ECF 2557 |
| | | | | and 5% formic |
| | | | | acid ester |
| % Return to Flow: | w/ spent | 0 | <5 | 31 |
| Injectivity | w/ water | 0 | <15 | 47.4 |

| | | | |
|---|---|---|---|
| % Return to Flow: Productivity | <20 | <30 | 81.7 |

In the next set of experiments, the fluid loss and breakthrough properties for OBM formulations aged for various time periods was assayed. As seen in Table 3, when compared to the baseline test results on base mud in Sample 1, the return to flow of Sample 2 containing a mixed mud with internal breaker after 16 hour hot roll, is improved by more than 50% in injectivity response and more than 30% in productivity. Sample 3 demonstrates that mixed mud maintains its fluid loss control ability after 2 weeks aging at 200° F. (93° C.), which indicates that the heat aging does not deactivate the function of PGA. It is also noted that in the absence of the DS acid source, mixed mud behaves similar to that of base mud and the acid source appears to accelerate the activation of the PGA and increase the degradation of the deposited filter cake.

TABLE 3
Breaker test results for base mud with and
with 6.5 ppb internal PGA breaker.

| | | Sample | | | |
|---|---|---|---|---|---|
| | | 1 | 2 | 3 | 4 |
| | | Mud type: 9.5 ppg VersaPro | | | |
| | | | Base + | Base + | |
| | | | 6.5 ppb | 6.5 ppb | Base + |
| | | Base | PGA, | PGA | 6.5 ppb |
| | | Mud | (16 hr HR) | (2 w aging) | PGA |
| Soaking fluid/external | | 10 v % ECF 2557 and 5% | | | 10 v % ECF |
| breaker | | D-Structor in 10 ppg CaBr₂ | | | 2557 |
| Spurt loss, ml | | 3.2 | 2.0 | 2.8 | 2.2 |
| Fluid loss, ml, | | 10.6 | 5.8 | 7.4 | 7.4 |
| 4 hrs | | | | | |
| Break through | | 2 min | 8 min | 2 min | 10 min |
| % Return to | w/ spent | 14.2 | 26.5 | 50.9 | 11.9 |
| Flow: Injectivity | w/ water | 36.8 | 41.0 | 55.8 | 23 |

| | | | | |
|---|---|---|---|---|
| % Return to Flow: | 59.3 | 88.5 | 70.3 | 53.8 |
| Productivity | | | | |

### Example 3

In the next example, the clean-up properties of filter cakes deposited by various OBM formulations, including those with an internal breaker, were studied by measuring injectivity and productivity changes when the filter cakes were exposed to various breaker fluids. Further, OBM formulations were prepared using polyglycolic acid (PGA) internal breakers having differing molecular weights and particle sizes. PGA internal breakers studied include a lower molecular weight PGA having a M_{w} of 600 and an average particle size of 20 microns, and a higher molecular weight PGA having a M_{w} of 20 kDa and an average particle size of 20 microns. Rheology for each of the OBM formulations was measured. Rheology and fluid loss characteristics of the OBM formulations are shown in Table 4.

TABLE 4
Rheology of internal breaker OBM formulations.

| | Mud type: 9.5 ppg VersaPro | |
|---|---|---|
| | 6.5 ppb PGA | 6.5 ppb PGA |
| Base | (low MW, 20 μm) | (high MW, 20 μm) |

Fann 35 @ 120 F.

| | | | |
|---|---|---|---|
| 600 | 70 | 61 | 60 |
| 300 | 43 | 35 | 35 |
| 200 | 33 | 26 | 26 |
| 100 | 23 | 15 | 16 |
| 6 | 9 | 5.5 | 5.5 |
| 3 | 8 | 4.5 | 4.5 |
| ES | 419 | 228 | / |

Built filter cake on FAO-00 disk @ 200° F. (93° C.) and 500 psi

| | | | |
|---|---|---|---|
| Spurt (mL) | 4 | 2.8 | 3.2 |
| 4-hr fluid loss (mL) | 9.6 | 7.4 | 8.6 |

Next, flow back tests were performed substantially as described in Example 2 on VersaPro™ OBM after hot rolling (HR) at 200° F. (93° C.) for the indicated times with and without an internal breaker. Following heat aging, filter cakes were deposited and soaked for 5 days at 200° F. (93° C.) on a FAO-00 aloxite disk. Results are shown in Table 5.

TABLE 5
Flow back test comparing high and low molecular weight internal breaker OBMs.

| | | | 6.5 ppb PGA | | 6.5 ppb PGA | |
|---|---|---|---|---|---|---|
| | | | (low MW, 20 μm) | | (high MW, 20 μm) | |
| Mud type: 9.5ppg VersaPro | | Base | 16 hr HR | 2 wk HR | 16 hr HR | 1 wk HR |
| Soaking fluid/external breaker | | 10 v % ECF 2557 + 5 v % DS in 10.0ppg CaBr₂ | | | | |
| Break through | | 25 hr | 3 min | 2 min | 20 min | 1 min |
| % Return to Flow: Injectivity | w/ spent | 10.4 | 44.1 | 50.9 | 70.4 | 80.8 |
| | w/ water | 52.6 | 46.7 | 55.8 | 72.8 | 93.1 |
| % Return to Flow: Productivity | | 68.1 | 84.7 | 70.3 | 85.6 | 92.3 |

Fluid loss control and flow back tests were also conducted on OBM formulated with a high molecular weight internal breaker having an average particle size of 200 μm. Following heat aging, filter cakes were deposited and soaked for 5 days in the specified external breaker fluid at 200° F. (93° C.) on a FAO-00 aloxite disk. Results are shown in Table 6.

TABLE 6
Fluid loss and flow back data for high
molecular weight internal breaker.

| | | Mud type: 9.5 ppg VersaPro | |
|---|---|---|---|
| | | | Base + 6.5 ppb PGA |
| | | Base | (high MW, 200 mm) |
| Soaking fluid/external breaker | | 10 v % ECF 2557 + 15 v % DS | |
| Spurt loss, ml | | 3 | 5 |
| Fluid loss, ml, 4 hrs | | 7.7 | 10.8 |
| Break through | | 20 min | 1.5 min |
| % Return to Flow: | w/ spent | 73.1 | 78 |
| Injectivity | w/ water | 85.8 | 91.4 |

| | | |
|---|---|---|
| % Return to Flow: Productivity | 84.8 | 91.6 |

### Example 4

In the next series of tests, cleanup assays were performed on a contaminated field mud and barite laden mud to study the performance of PGA as internal breaker when combined with materials encountered during drilling operations. Contaminated fluids were formulated from 9.5 ppg VERSAPRO™ mud containing 4% by volume of a contaminant containing 75% by volume silica flour and 25% by volume. Samples were also formulated to contain 6.5 ppb of low M_{W} PGA. Following formulation, the rheology of the samples was measured before hot roll (BH) and after hot roll at 200° F. (93° C.) for 16 hours (AH). Results are shown in Table 7.

TABLE 7
Rheology of contaminated mud with internal breaker.

| Fann 35 | Contaminated | Contaminated + low MW |
|---|---|---|
| @ 150° F. | BH/AH | 6.5 ppb PGA BH/AH |
| 600 RPM | 90/98 | 96/95 |
| 300 RPM | 54/59 | 59/57 |
| 200 RPM | 41/45 | 45/43 |
| 100 RPM | 27/29 | 30/27 |
| 6 RPM | 9/10 | 10/8 |
| 3 RPM | 8/9 | 9/7 |
| PY | 36/39 | 37/38 |
| YP | 18/20 | 22/19 |
| Access Lime | 2.34/1.95 | 1.36/0 |
| ES | 310/423 | 296/135 |

Flow back tests were conducted as discussed in Example 2. Flow back was assayed with both water alone and spent brine. Results are shown in Table 8 for both high and low molecular weight PGA.

TABLE 8
Flow back test with contaminated OBM
formulations containing internal breaker.

| | | Mud type (9.5 VersaPro) | | |
|---|---|---|---|---|
| | | | 6.5 ppb PGA | 6.5 ppb PGA |
| | | | (low MW, | (High MW, |
| | | Contaminated | 20 μm) | 50 μm) |
| Soaking | | 10 v % ECF 2557 + 15 v % | | |
| fluid/external breaker | | DS in 10.5 ppg CaBr2 | | |
| Spurt loss, mL | | 2.6 | 3.5 | 1.8 |
| Fluid loss, mL, 4 hr | | 5.6 | 9.2 | 6.8 |
| Break through | | no | 5 days | — |
| % Return to | w/ | 1.6 | 2.7 | 71.9 |
| Flow: | spent | | | |
| Injectivity | w/ | 72.3 | 25 | 82.6 |
| | water | | | |

| | | | |
|---|---|---|---|
| % Return to Flow: | 88.5 | 84.2 | 90.3 |
| Productivity | | | |

Next, experiments were conducted on a 12.5 ppg wellbore fluid formulated with a barite weighting agent. Samples were also prepared with 6.5 ppb low MW PGA. OBM was formulated as shown in Table 9.

TABLE 9
Barite-laden OBM formulation.

| Component | lb/bbl |
|---|---|
| Synthetic Oil (IO 1618) | 11.69 |
| VG SUPREME | 2 |
| lime | 4 |
| SUREMUL | 8 |
| SUREWET | 4 |
| 11.6 ppb CaCl₂ | 87.19 |
| water | 50.67 |
| M-I BAR | 85 |
| SAFE-CARB 2 | 40.17 |
| SAFE-CARB 10 | 114.63 |
| SAFE-CARB 20 | 17.64 |

Following formulation, the rheology of the samples was measured before hot roll (BH) and after hot roll at 200° F. (93° C.) for 16 hours (AH). Results are shown in Table 10 for contaminated mud and contaminated mud with low molecular weight PGA.

TABLE 10
Rheology of barite-laden OBM with internal breaker.

| Fann 35 | Contaminated | Contaminated + 6.5 ppb low |
|---|---|---|
| @ 150° F. | BH/AF | MW PGA HH/AH |
| 600 RPM | 122/93 | 121/109 |
| 300 RPM | 80/50 | 79/68 |
| 200 RPM | 65/35 | 63/53 |
| 100 RPM | 46/20 | 45/37 |
| 6 RPM | 18/4 | 17/13 |
| 3 RPM | 16/3 | 15/11 |
| PY | 42/43 | 42/41 |
| YP | 36/7 | 37/27 |
| ES | 216/292 | 252/179 |

Following formulation, flow back tests were conducted substantially as described in Example 2. Flow back was assayed with both water alone and spent brine. Results are shown on Table 11.

TABLE 11
Breaker test with barite-laden OBM with internal breaker

| | | 12.5 ppg OBM | | |
|---|---|---|---|---|
| | | | Base + 6.5 | Base + 6.5 |
| | | | ppb PGA | ppb PGA |
| | | | (low MW, | (High MW |
| | | Base | 20 μm) | 50 μm) |
| Soaking fluid/external breaker | | 10 v % ECF 2557 + 15 | | |
| | | v % DS in 14.2 ppg CaBr2 | | |
| Spurt loss, ml | | 2.2 | 0.8 | 2.5 |
| Fluid loss, ml, 4 hrs | | 7.8 | 12.2 | 10.8 |
| % Return to Flow: | w/ spent | 1.9 | 1 | 2 |
| Injectivity | w/ water | 7.7 | 2.9 | 23.8 |

| | | | |
|---|---|---|---|
| % Return to Flow: Productivity | 50.9 | 94.5 | 91.7 |

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method comprising:
circulating a first wellbore fluid into a wellbore, wherein the first wellbore fluid comprises:
a non-aqueous continuous phase, and
a polyester internal breaker,
wherein the first wellbore fluid generates a filter cake in at least a section of the wellbore;
circulating a second wellbore fluid into the wellbore, wherein the second wellbore fluid comprises an acid source and a surfactant; and
allowing the second wellbore fluid to degrade at least a portion of the filter cake.

2. The method of claim 1, wherein the polyester internal breaker is one or more selected from a group consisting of polyglycolic acid, polylactic acid, and copolymers of lactic and glycolic acid.

3. The method of claim 1, wherein the concentration of the polyester in the first wellbore fluid is in the range of about 0.5 ppb to 15 ppb.

4. The method of claim 1, wherein the polyester internal breaker has an average particle size within the range of about 10 μm to 200 μm.

5. The method of claim 1, wherein the second wellbore fluid comprises an acid source, and wherein the acid source is a hydrolysable ester.

6. The method of claim 1, wherein the acid source is a formic acid ester.

7. The method of claim 1, wherein the acid source is a hydrolyzable ester of comprising an ester prepared from a C1 to C6 carboxylic acid and a C2 to C30 poly alcohol.

8. The method of claim 1, wherein the polyester internal breaker has a molecular weight in the range of 200 Da to 30 kDa.

9. The method of claim 1, wherein the polyester internal breaker has a molecular weight in the range of 800 Da to 50 kDa.

10. The method of claim 1, wherein the surfactant of the second wellbore fluid comprises a surfactant blend containing an alkyl polyglycoside, an ethoxylated alcohol, and a polyethyleneglycol monobutyl ether.

11. The method of claim 1, wherein the surfactant of the second wellbore fluid comprises an ethoxylated quaternary ammonium chloride.

12. The method of claim 1, wherein the second wellbore fluid further comprises a chelant.

13. A method comprising:
circulating a wellbore fluid into a wellbore drilled with an oil-based mud containing a polyester fluid loss additive, wherein the wellbore fluid comprises one or more surfactants and an acid source.

14. The method of claim 13, wherein the polyester internal breaker is one or more selected from a group consisting of polyglycolic acid, polylactic acid, and copolymers of lactic and glycolic acid.

15. The method of claim 13, wherein the acid source is a hydrolyzable ester.

16. The method of claim 13, wherein the acid source is a hydrolyzable ester of comprising an ester prepared from a C1 to C6 carboxylic acid and a C2 to C30 poly alcohol.

17. The method of claim 13, wherein the acid source is a formic acid ester.

18. The method of claim 13, wherein the one or more surfactants comprises a surfactant blend containing an alkyl polyglycoside, an ethoxylated alcohol, and a polyethyleneglycol monobutyl ether.

19. The method of claim 13, wherein the wellbore fluid further comprises a chelant.

20. The method of claim 13, wherein the surfactant of the second wellbore fluid comprises an ethoxylated quaternary ammonium chloride.
